(19) United States
(12) Patent Application Publication
(10) Pub. No.: US 2023/0410072 A1
(43) Pub. Date: Dec. 21, 2023

(54) SYSTEMS AND METHODS FOR ENHANCED NON-FUNGIBLE TOKENS

(71) Applicant: Tantamount Labs, Atlanta, GA (US)

(72) Inventors: Katelyn Perna, Atlanta, GA (US); Anthony Tellez, Mesa, AZ (US)

(73) Assignee: Tantamount Labs, Atlanta, GA (US)

(21) Appl. No.: 18/141,561

(22) Filed: May 1, 2023

Related U.S. Application Data
(60) Provisional application No. 63/353,653, filed on Jun. 20, 2022.

(51) Int. Cl. G06Q 20/12; G06Q 20/38

(52) U.S. Cl. CPC G06Q 20/1235; G06Q 20/3829; G06Q 2220/00

(57) ABSTRACT

An enhanced non fungible token (NFT) is provided that provides mechanisms for confirming ownership of a digital asset as well as authenticating the origin of that digital asset. The asset is provided with an encrypted origin token that is steganographically inserted into the media prior to minting the NFT. Information in the origin token is verifiable by the asset origin once decrypted. Systems and methods for generating and authenticating the enhanced NFT are also provided.

### CROSS REFERENCE TO RELATED APPLICATIONS

This application claims the benefit of priority to U.S. Provisional patent application Ser. No. 63/353,653 filed on Jun. 20, 2022 and entitled SYSTEMS AND METHODS FOR ENHANCED NON-FUNGIBLE TOKENS, the disclosure of which is hereby incorporated by reference in its entirety.

### FIELD OF THE INVENTION

The present invention relates generally to the protection of digital assets and more particularly relates to improved security for digital assets.

### BACKGROUND

A non-fungible token (“NFT”) is a digital asset that is intended to be unique, thereby preserving value. Unlike traditional digital media, an NFT cannot be copied, substituted, or subdivided, and is recorded in a blockchain that is used to certify authenticity and ownership. For example, an electronic image, such as a JPEG file, may be easily reproduceable countless times, with each copy being identical to the original, making the image a low-value commodity. An NFT of that image, on the other hand, has information associated with a smart contract recorded in a blockchain that is intended to make the asset unique and verifiable. The ownership of an NFT is recorded in the blockchain and can be transferred by the owner, allowing NFTs to be sold and traded. With the growth of the crypto-industry and improvements in underlying technology, such as cryptographic and blockchain technologies, the acceptance and popularity of NFTs has been rapidly accelerating. As recently reported by Chainalysis, in 2021 alone NFT collectors spent $44.2 Bil on ERC-721 and ERC1155 contracts related to NFTs.

FIG. 2 illustrates the overview of the basic flow of the current process of “minting” an NFT. “Minting” has become a term of art which refers to the initial creation and recording of an NFT on a blockchain. A creator of an electronic asset, such as a song, picture, video, document, image, photo, and the like, creates an original work and then executes code stored in a smart contract to define parameters of ownership and transferability of the resulting NFT. The attributes and metadata of the work and the associated smart contract are then recorded as a new block on a blockchain.

Smart contracts, which are generally known in the art, are digital contracts that are stored on a blockchain that are automatically executed when predetermined terms and conditions are satisfied. Depending on the properties of the blockchain platform being used, one or more standards defining the attributes of a smart contract may be used. For example, NFTs on the Ethereum platform generally conform to standards such as ERC-721. This is merely exemplary, however, and the present methods are not limited to any particular platform or standard.

Once recorded on the blockchain, it is intended that buyers and sellers of the NFT can verify the bona fides of the NFT by verifying the public cryptographic blockchain entry. If the NFT is transferred to another owner, that transaction is recorded on the blockchain, thereby allowing the chain of ownership from the point of minting to be verifiable.

Although NFTs currently provide the ability to verify that a particular digital asset was minted and recorded on a blockchain, the current methods of minting and distributing NFTs are still limited in the ability to prevent third parties from taking a creator's original work and minting new NFTs without the creator's authorization. Indeed, Opensea has recently reported that approximately 80% of newly minted collections of NFTs include stolen art, fakes, spam, or otherwise unoriginal media. Currently, the primary verification offered by popular marketplaces is user account verification, which does not solve the verification problem at the NFT/asset layer. Unfortunately, accounts are subject to hijacking; account takeovers, and the account verification process can be easily manipulated. In addition, NFTs can be easily forged across multiple blockchains and platforms regardless of account verification. As a result, the market is currently plagued with copycats and counterfeit NFTs, undermining the very purpose and value of NFTs.

Thus, there remains a need to further improve the security of digital assets, especially with respect to verifying the origin of an NFT.

### SUMMARY OF THE DISCLOSURE

The current disclosure presents enhanced methods of NFT creation and verification. The present systems and methods employ cryptography to generate an origin token and steganography to embed the origin token into the media in a manner that does not alter the media to human perception. The media, with its embedded origin token, is then minted as an NFT. A third party wishing to validate the NFT can confirm transaction details from the point of minting the NFT to present using the blockchain. The third party can also validate the origin authenticity of the NFT by rendering the origin token from the NFT and validating the origin token, such as with a public key made available by the creator, NFT creation platform, or public key registry.

In accordance with the present disclosure, an enhanced NFT providing origin authentication includes digital media that is created at an origin. An origin token is provided which includes information verifiable by the origin/originator and being encrypted with a private key associated with the origin. The origin token is steganographically embedded into the media prior to minting of the NFT, such that the media is not altered to human perception. By extracting the origin token from the NFT, decrypting the origin token using a matching public key associated with the origin, and verifying the information in the origin token, the origin and authenticity of the media can be confirmed.

A method of creating an enhanced non-fungible token (NFT) for digital media is also presented. The method includes generating an origin token comprising information associated with the media originator, encrypting the origin token with a key associated with the originator, steganographically embedding the encrypted origin token into the digital media; and minting the enhanced NFT including the digital media and encrypted origin token.

The method of creating an enhanced NFT can include encrypting the origin token using a private key of a public-private key pair. In one embodiment, the public-private key pair can be a GPG key pair. In certain embodiments, the origin token can include a hash value of the media prior to embedding the origin token. The public key hosted by either the NFT platform or made available by a public key server.

A method of authenticating an enhanced NFT of digital media is also provided. This authentication method includes verifying, via a blockchain, all transactions for the NFT from the point of minting to present. The method further includes extracting or rendering an encrypted origin token that was embedded in the media with steganography, decrypting the origin token with a public key associated with the origin of the media to obtain an origin signature, and validating the origin signature.

### BRIEF DESCRIPTION OF THE FIGURES

FIG. 1 is a simplified flow diagram illustrating a known method of NFT creation;

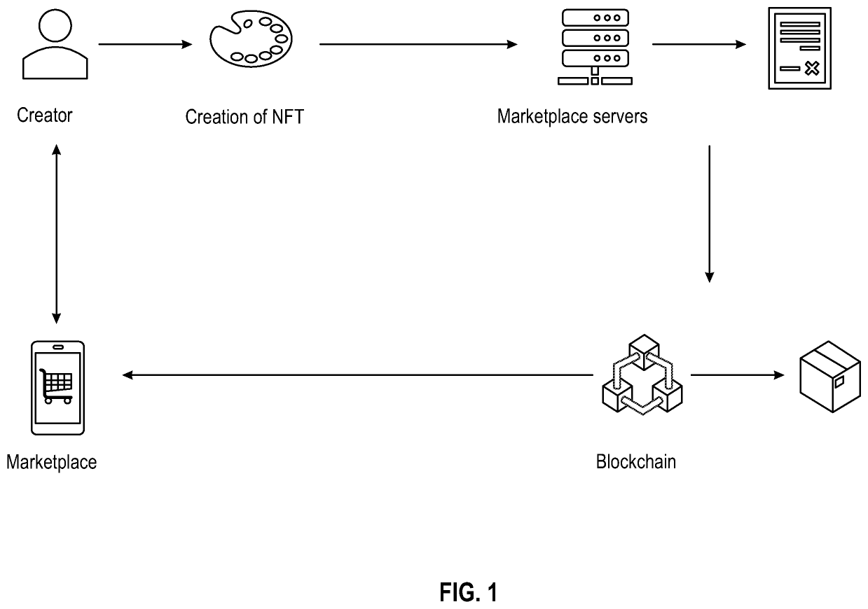

FIG. 2 is a simplified flow diagram illustrating a method of “minting” an NFT;

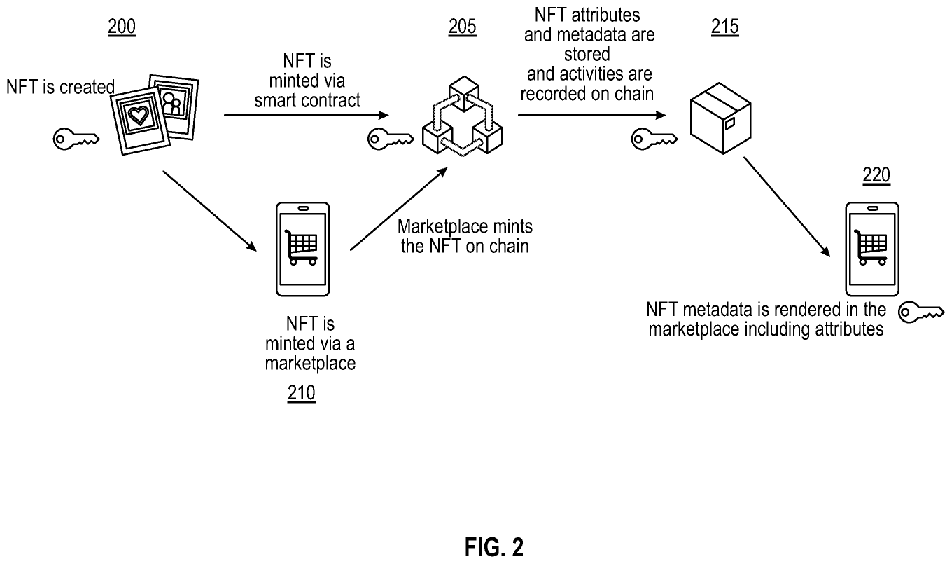

FIG. 3 is a simplified flow diagram illustrating a method of generating an enhanced NFT in accordance with the present disclosure;

FIG. 4 is a simplified flow diagram of an improved system and method NFT creation and verification using an embedded cryptographic signature;

FIG. 5A is a simplified flow diagram illustrating a method of inserting a cryptographic signature into media that does not perceptibly alter the media;

FIG. 5B is a simplified flow diagram illustrating a method for validating media with an integral cryptographic signature.

FIG. 6 is a simplified flow diagram further illustrating and example of authenticating an origin token in accordance with the present systems and methods.

### DETAILED DESCRIPTION

The present systems and methods for enhanced NFT creation and validation involve the embedding of a unique cryptographic signature into a piece of digital media prior to creating and minting the NFT. As used herein, such a signature which is used to verify the creator or origin of the NFT is referred to as an “origin token.” Thus, not only is the smart contract metadata of the NFT recorded on the blockchain to confirm the chain of ownership of the work, but the work itself has an imperceptible (to human perception) cryptographic signature that can be used to validate the origin of the underlying media. This generally involves embedding the origin token into the media that cryptographically verifies its origin by signing the media using a private key and embedding the origin token into the media using steganography. This information in the origin token may be layered into the properties of the NFT and can be subsequently verified by checking the blockchain transaction metadata. Thus, not only will the enhanced NFT of the current systems and methods have a readily traceable chain of title tracking each transaction after minting, the origin of the NFT can be independently verifiable.

Steganography is a technique for hiding secret data within an ordinary, non-secret, file or message in order to avoid detection. For example, a document can be steganographically embedded into an image file without changing the visual appearance of the image. A user who is aware of the presence of the secret data can then extract that information from the file. By its nature, the use of steganography to embed data within a file should not perceptibly alter the media. Known methods of steganography can be used to embed data into image files, sound files, and other media files in various ways that do not result in perceptible changes to the media. For example, various tools are currently available, such as Stegano or OpenStego, to use steganography to embed content into image files and subsequently retrieve the embedded content.

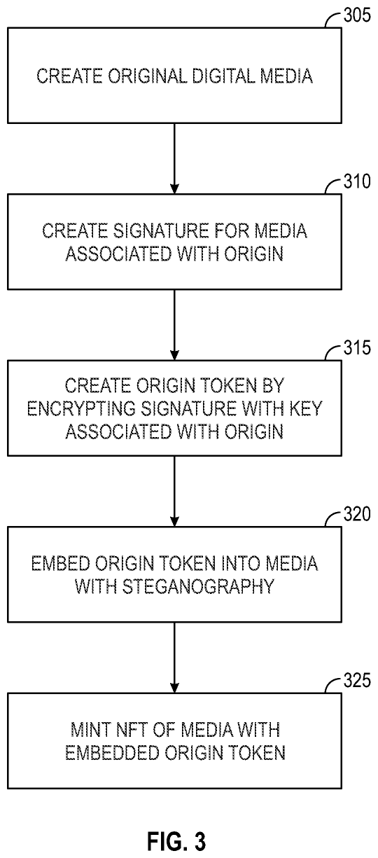

FIG. 3 is a simplified flow diagram illustrating a method for generating an enhanced NFT in accordance with the present disclosure. In step 305, digital media which will be the subject of the NFT is created. The digital media can take many forms including text, images, video, audio and the like. In step 310 the originator of the digital media creates a digital signature that preferably includes information associated with the origin of the work and can be authenticated by the originator. In step 315, the signature information is encrypted, preferably with a private key associated with the originator of the digital media to form an origin token. In step 320, the origin token is then embedded into the digital media using steganography. This process embeds the origin token into the digital media in a manner that is not perceptible to a human consuming the digital media. In other words, the steganography process is not visible or audible to a person when viewing and/or listening to the digital media. In step 325, the digital media with the embedded origin token is minted as an NFT in a manner generally known in the art, generating an entry on a blockchain ledger.

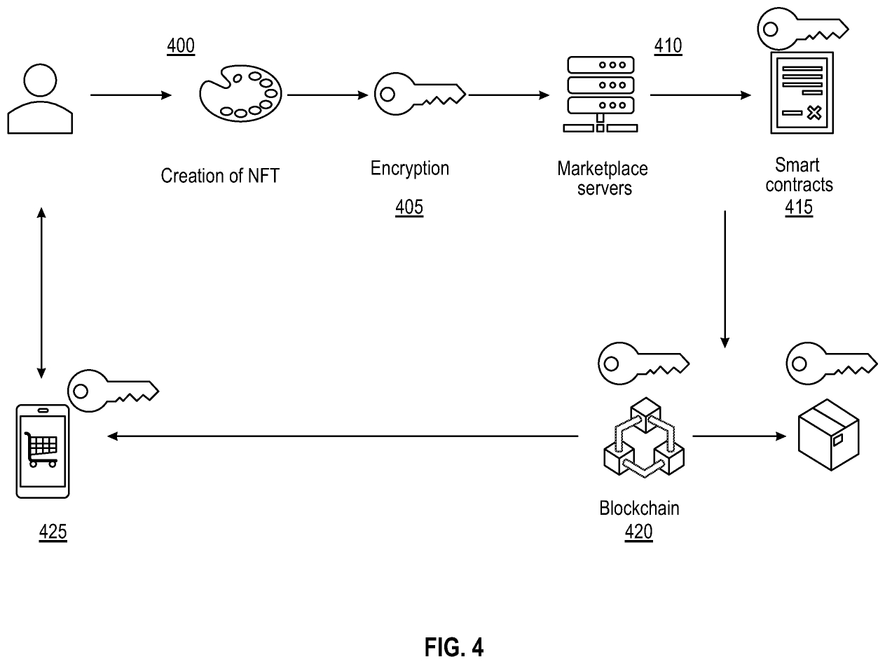

FIG. 4 is a simplified schematic diagram of the present methods for creating and verifying an enhanced NFT with origin authentication. Referring to FIG. 4, at step 400 a user creates an electronic work that she wishes to distribute as an NFT. The nature of the work or specific media in which the work is created is not limited and can take any virtually any form, ranging from physical objects to various forms of electronic media including but not limited to text, audio, graphics, images, video and the like. Before using the smart contract to generate and record the appropriate data and metadata on the blockchain, an origin token is created and steganography is used to embed the origin token into the media (Steps 400, 405). At 410, 415 the NFT including the embedded origin token is minted using the marketplace servers or via smart contracts. The metadata and smart contract parameters of the NFT are recorded in a block chain at 420. Preferably, this data includes a public origin address that specifies the location of the information needed to extract and verify the origin token. Once minted, the bona fides of the NFT can be authenticated via the blockchain. The information required to verify the origin token, such as a public key in a public/private key pair, is preferably stored independently of the block chain record. By extracting the embedded origin token and retrieving the appropriate public key, the origin of the media can be verified.

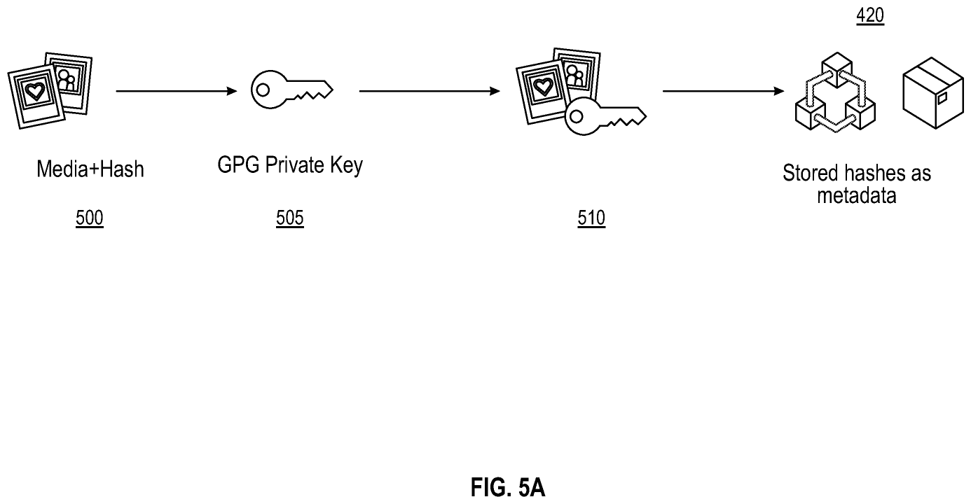

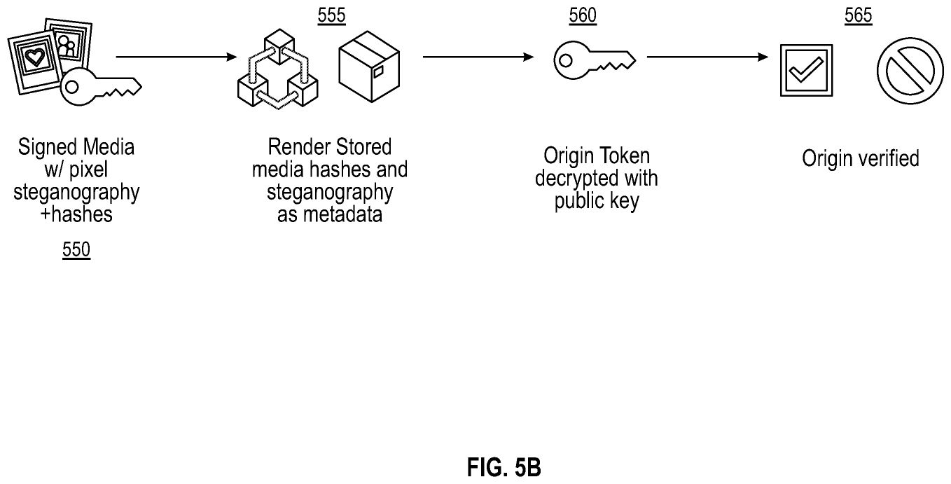

FIG. 5A is a simplified schematic diagram further illustrating a method of creating and embedding an origin token into media to be minted into an NFT. In one preferred embodiment, a private key in a private key/public key pair, such as a GPG key pair, is used to create the origin token. It will be appreciated, however, that other forms of encryption may be employed.

The origin token may include information about the media, the creator, or even random information that is not publicly known and is independently verifiable once extracted and decrypted. In one example, the origin token can include data related to the media and the wallet that will mint the NFT (Step 500). For example, a wallet identifier, e.g., wallet 0x022E4, can be stored as a hash in the media. In addition, a hash value of the media itself can be determined prior to embedding the origin token (pre-processed hash), e.g., hash 49152:Pa+.

The wallet and media hash data can be combined and signed with a private key, (Steps 405,505) providing an origin token that can be verified by a third party with an appropriate matching public key (step 510) from a key server. It will be appreciated that although not readily perceptible to a human observer, steganographically embedding the origin token modifies the data and will result in a different hash value of the processed media (post-processing hash), e.g.: 49152:Qb!. This post-processing hash can be included in the contract/properties of the media when stored in a data repository (step 520), such as the blockchain or peer-to-peer file sharing system such as Interplanetary File System (“IPFS”) and can be used to help identify unauthorized copies or forgeries by leveraging the similarity to the original hash.

It will be appreciated that there are a wide range of methods that can be used to generate the origin token. In one embodiment, tools available at Keybase.io can be used to generate a signature and pin a public PGP key. Other services that support PGP or public key infrastructure can also be used, so long as the public key is available via IPFS, S3 or pinned somewhere permanent for verification purposes. In one example, ssdeep, an open-source algorithm, can be used to create a rolling hash of the NFT media. Keybase is an example of software that can be used to generate an output signature to be embedded in the media using saltpack. That signed message can then be used with the stegano software to modify the media file to include this digital signature.

In one embodiment, the hash function can be a fuzzy hashing algorithm, such as ssdeep, in addition to SHA hashes, such as those produced automatically by s3file storage. Other fuzzy hashing algorithms, such as those used in malware analysis to identify similar files with slight modifications, can also be used. Further information regarding fuzzy hashing algorithms is discussed in the article “Lempel-Ziv Jaccard Distance, an Effective Alternative to Ssdeep and Sdhash,” by Rafl et al., preprint submitted to Digital Investigation, Feb. 16, 2018 and available at https://arxiv.org/pdf/1708.03346.pdf, the disclosure of which is hereby incorporated by reference in its entirety.

It will be appreciated that the present systems and methods are not limited to any particular cryptographic method of creating and/or verifying the origin token. Indeed, any method of creating an embeddable cryptographic token that can be subsequently verified by a third party using an appropriate cryptographic method may be used.

Once created, regardless of the underlying information used to generate the origin token, the origin token is embedded into the media using steganography, such as pixel steganography. The media with the embedded origin token is then minted as an NFT.

FIG. 5B is a simplified flow diagram illustrating a method of validating an enhanced NFT 550 in accordance with the present methods. Validation begins by evaluating the smart contracts of an NFT, which for example can be in the form of ERC-721 & ERC-1155 Contracts, to determine the party who first minted the media/content and determine a public origin address for the NFT. For example, the project may have a public wallet (0x022E4) and the transaction at the time of minting the media can be checked against the metadata encoded into the media itself. The origin token embedded into the NFT can be extracted from the media and decrypted using the public key of an NFT project or collection. This decrypted data may be human readable text and may contain hashes related to the media prior to minting and the wallet that minted the media. For example the decrypted origin token might contain the following information: Hash of the original image (49152:Pa+), wallet that minted the NFT (0x022E4), e.g., official social media handles, project documentation or human readable text. It will be appreciated that this is simply one illustrative example. The specific content of the origin token is not critical to the present systems and methods and can include any text or data suitable for verification of the token.

The third party wishing to validate the NFT can render the pixel steganography to extract the encrypted origin token (Step 555) and can use the public key, obtained by the public origin address or other information in the smart contract, to decrypt the origin token (step 560). The information in the decrypted origin token can be verified based on the ability to decrypt the origin token and matching the metadata and information in the IPFS and/or smart contract metadata (step 565). Alternatively, the decrypted origin token may be verifiable by a third-party website securely maintaining information needed to validate the origin token.

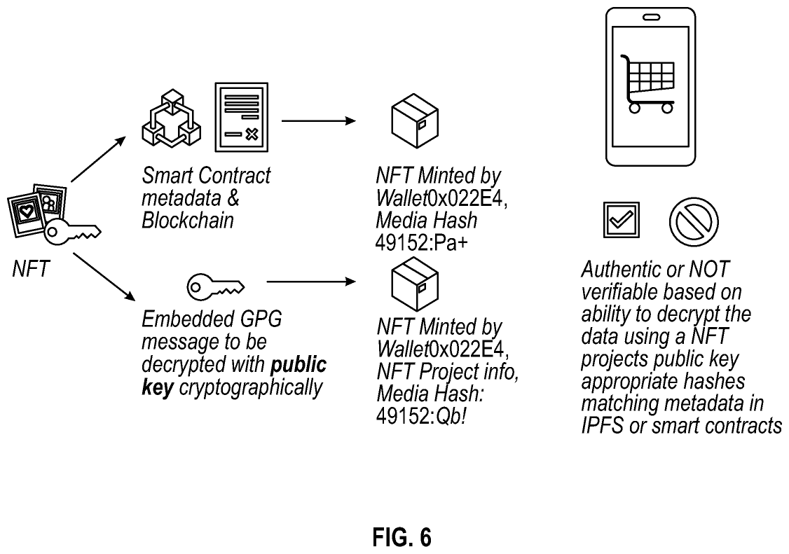

FIG. 6 further illustrates the two paths of verification of an enhanced NFT in accordance with the present methods. In the top flow path, data, and metadata on the blockchain are verifiable in a traditional manner for NFTs. In the bottom flow path, and in parallel with the blockchain verification, the origin token is extracted and decrypted. The NFT can be verified if the origin token can by decrypted using a project's public key and information, such as the minting wallet identification and the hash values of the media can be confirmed with a shared similarity.

Even in the case of a so-called lazy mint (e.g., a process used by some vendors, such as OpenSea, where the information to create an NFT is available, but the NFT is only minted once the NFT is sold), the wallet that receives the NFT will be considered the origin and can be validated so long as the cryptographic function used to generate the origin token is performed before the media is put into IPFS or made available on the NFT marketplace. Alternatively, a minter can transfer the NFT to the origin wallet to establish the chain of custody properly on the blockchain, for example: send the NFT from wallet 0x022E4 to wallet 0x022E4. It will be appreciated that so long as the private keys of a project used to create the origin token are kept safe, forgeries of NFT media will be difficult to create. It will be appreciated that the information used to create the origin token, such as the original media hash, must be different than what is human readable in the media (and otherwise not publicly known) to prevent an illicit user from simply encoding false hashes into the media.

The present systems and methods are applicable to virtually any form of electronic media for which the creator wishes to generate an NFT, including photos, electronic art, videos, text files, music files, and the like. It will be appreciated that various forms of steganography may be better suited based on the media type. For example, pixel steganography may be preferable in the case of visual works. The present disclosure, however, is not limited to any particular form of steganography algorithm.

It is to be noted that any one or more of the aspects and embodiments described herein may be conveniently implemented using one or more machines (e.g., one or more computing devices that are utilized as a user computing device for an electronic document, one or more server devices, such as a document server, etc.) programmed according to the teachings of the present specification, as will be apparent to those of ordinary skill in the computer art. Appropriate software coding can readily be prepared by skilled programmers based on the teachings of the present disclosure, as will be apparent to those of ordinary skill in the software art. Aspects and implementations discussed above employing software and/or software modules may also include appropriate hardware for assisting in the implementation of the machine executable instructions of the software and/or software module. It is further understood that the present systems and methods may involve interconnection among devices which communicate over a computer network, such as local area networks, wide area networks, and global networks such as the internet.

Such software may be a computer program product that employs a machine-readable storage medium. A machine-readable storage medium may be any medium that is capable of storing and/or encoding a sequence of instructions for execution by a machine (e.g., a computing device) and that causes the machine to perform any one of the methodologies and/or embodiments described herein. Examples of a machine-readable storage medium include, but are not limited to, a magnetic disk, an optical disc (e.g., CD, CD-R, DVD, DVD-R, etc.), a magneto-optical disk, a read-only memory “ROM” device, a random-access memory “RAM” device, a magnetic card, an optical card, a solid-state memory device, an EPROM, an EEPROM, and any combinations thereof. A machine-readable medium, as used herein, is intended to include a single medium as well as a collection of physically separate media, such as, for example, a collection of compact discs or one or more hard disk drives in combination with a computer memory. As used herein, a machine-readable storage medium does not include transitory forms of signal transmission.

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine (e.g., a computing device) and any related information (e.g., data structures and data) that causes the machine to perform any one of the methodologies and/or embodiments described herein.

Examples of a computing device include, but are not limited to, an electronic book reading device, a computer workstation, a terminal computer, a server computer, a handheld device (e.g., a tablet computer, a smartphone, etc.), a web appliance, a network router, a network switch, a network bridge, any machine capable of executing a sequence of instructions that specify an action to be taken by that machine, and any combinations thereof. In one example, a computing device may include and/or be included in a kiosk.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

What is claimed:

1. A method of creating an enhanced non-fungible token (NFT) for digital media, the method comprising:
generating an origin token comprising information associated with the media originator;
encrypting the origin token with an encryption key associated with the media originator;
steganographically embedding the encrypted origin token into the digital media; and
minting the enhanced NFT including the digital media and encrypted origin token.

2. The method of creating an enhanced NFT of claim 1, wherein the origin token is encrypted using a private key of a public-private key pair.

3. The method of claim 2, wherein the public-private key pair a GPG key pair.

4. The method of creating an enhanced NFT of claim 1, wherein the origin token includes a hash value of the media prior to embedding the origin token.

5. A method of authenticating an enhanced NFT of digital media comprising:
verifying, via a blockchain, the chain of transactions from the point of minting to the present;
extracting an encrypted origin token that was embedded in the media with steganography prior to minting the NFT;
decrypting the origin token with a public key to obtain an origin signature; and
validating the origin signature.

6. The method of authenticating an enhanced NFT of claim 5, wherein the origin token includes data related to the content of the digital media.

7. The method of authenticating an enhanced NFT of claim 5, wherein the data related to the content of the digital media is a hash value of the media prior to embedding the origin token in the media.

8. An enhanced NFT providing origin authentication comprising:
digital media created at an origin;
an origin token, the origin token having information verifiable by the origin and being encrypted with a private key associated with the origin, the origin token being steganographically embedded into the media prior to minting of the NFT such that the media is not altered to human perception.

9. An enhanced NFT of claim 8, wherein the origin token includes data related to the content of the digital media.

10. An enhanced NFT of claim 9, wherein the data related to the content of the digital media is a hash value of the media prior to embedding the origin token in the media.

11. An enhanced NFT of claim 8, wherein the digital media comprises an image and the origin token is embedded using pixel steganography.

12. Computer readable media having instructions stored therein for a computer to create an enhanced non-fungible token (NFT) for digital media, the instructions comprising:
generating an origin token comprising information associated with the media originator;
encrypting the origin token with an encryption key associated with the media originator;
steganographically embedding the encrypted origin token into the digital media; and
minting the enhanced NFT including the digital media and encrypted origin token.
